(19) United States
(12) Patent Application Publication
(10) Pub. No.: US 2002/0089208 A1
(43) Pub. Date: Jul. 11, 2002

(54) Shade

(76) Inventor: Debbie Mashborn, Brooklyn, NY (US)

Correspondence Address: Debbie Mashburn, 7402 BAY PARKWAY APT B8, BROOKLYN, NY, 11204, US

(21) Appl. No.: 10/029,564

(22) Filed: Dec. 28, 2001

Related U.S. Application Data
(60) Provisional application No. 60/259,175, filed on Jan. 3, 2001.

(51) Int. Cl. B60J 3/00

(52) U.S. Cl. 296/97.1; 296/152

(57) ABSTRACT

A visor that is made of a thin piece of resin plastic, which folds at the top. This fold has magnets on it which faciliates the easy removability of the shade. At the fold this shade attaches to the top of the car door outside the vehicle. This shade faciliates protection from the sun on the side of the face and the shade is treated with UV stablizer which prevents ultraviolet rays from passing therethrough.

### CROSS REFERENCE TO RELATED APPLICATIONS

Benefit of Provisional Patent Application No. 60/259,175 filed Jan. 3, 2001.

This invention relates to the magnets that allows this invention to be removable and not permenatly attached to the vehicle. In addition providing shade from the sun coming in from the side of the vehicle.

### BACKGROUND—DESCRIPTION OF PROIR ART

Automobiles come equipped with visors to offer some protection from the sun. Such visors are located inside the vehicle and these visors are permanently attached to the vehicle. Unfortunately sunlight often interferes with the driver's comfort level sunlight coming in from the side of the vehicle, which can distract one during driving.

Thereafter, inventors created several types of visors in an effort to protect you from the sun where the original visor the car provides fails.

U.S. Pat. No. 4,971,381 to Abu-Shumays (1990), U.S. Pat. No. D322,056 to Widrig (1991) and U.S. Pat. No. 5,730,484 to Robinson (1998) will protect you from the sun, however they are attached with hinges or clipped and fold down or hangs from the original visor inside the car. The attaching and removal of said visor may damage the original visor, become bothersome and dangerous to the driver when it is no longer needed or if you need to exit the vehicle quickly. While the existing units may be suitable for general use, they would not be suitable for the purpose of the present invention as disclosed hereafter.

### SUMMARY OF THE INVENTION

In accordance with the present invention a visor comprises a flat piece of resin plastic, having a 1″ curve from the top with heavy duty magnets in the three (3) boxes on the curve. It is an object of the present invention to provide shade to the driver from sunlight coming in from the side whereas, it is a further object of the present invention to provide a device that shields the driver or passangers from ultraviolet rays.

### DRAWING FIGURES

FIG. 1. 12″×6″ sheet piece of resin plastic with 1″ fold from the top to form a hanging appearance. High energy magnets 1/16 inches thick ¾ inches wide. These magnets are inserted in the box shapes on the 1 inch fold held in place with glue.

FIG. 2. An outside view of a car door showing shade attached to the door.

### DETAILED DESCRIPTION OF THE PREFERRED EMBODIMENT

The main objective of this invention is to contribute to the comfort of a driver and passengers of an automobile or similar vehicle. This is accomplished by making it possible to independently cover the side windows whenever it is desirable to do. The above and other aspects, features and advantages of the present invention will be more apparent from the following detailed description thereof, which is presented in conjunction with the following drawing(s) wherein corresponding reference characters indicate corresponding components throughout the drawing figures.

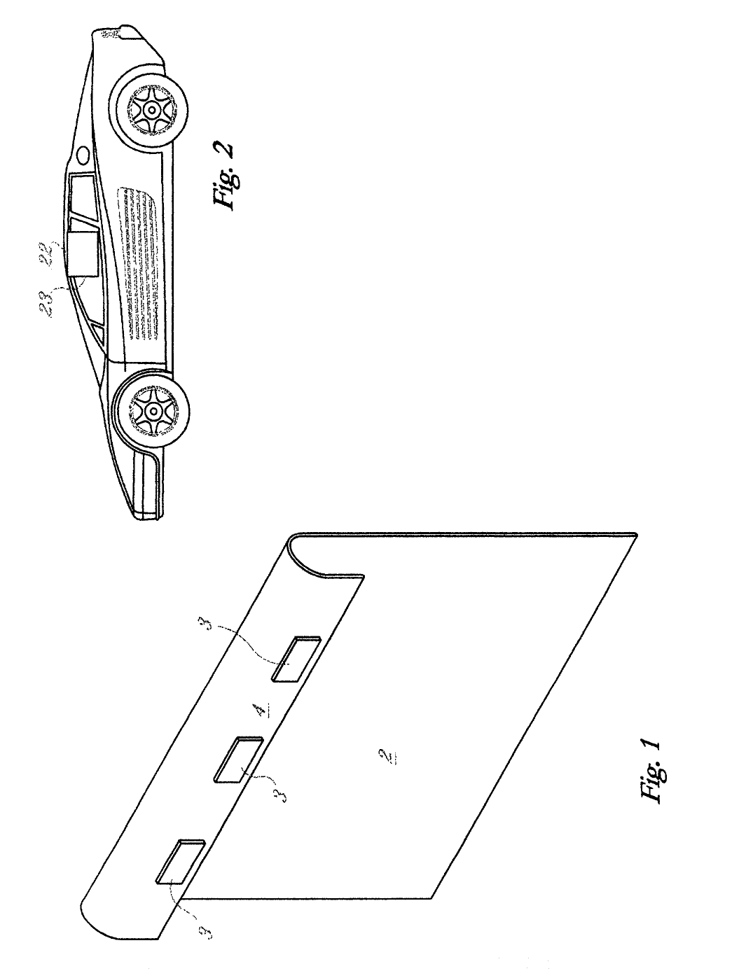

FIG. 1—Preferred embodiment of the present invention is illustrated in FIG. 1 a peice of resin plastic 2, a 12 inch by 6 inch, 0.090 thick candy cane shaped smoke color translucent sheet that is UV stablized, which will be bent from the top 4, 1 inch for the hanging effect. At the fold of the present invention 4, 3/16 inch heavy duty magnets will be inserted in the box shape 3 on the fold 4 held secure with glue.

FIG. 2—Illustrates the shade 23 attached to the vehicle door 22. It's detachable, does not require tools or sharp objects to assemble. Attaches to the outside 22 of the vehicle which will not interfere with the opening or closing of the windows or be bothersome to the driver.

Many specific details contained in the above description merely illustrate some preferred embodiments and should not be construed as a limitation on the scope of the invention. Accordingly, many other variations are possible within the spirit of the present invention, limited only by the scope of the appended claims.

Operation—FIGS. 1, 2

This structure 2 is placed outside of the vehicle on the car door 22 at the fold of the structure 4 which is then attached to the top of the car door by magnets 3. This structure acts as a shade from the sun to protect the side of the face and ear.

Conclusion, Ramifications, and Scope

Accordingly, the reader will see that this invention can be attached and removed easily and without damage to the car or inconvenience.

It permits the driver and passengers to have the protection from the sun coming in from the side of the vehicle he/she need without hassle.

It allows the driver not to worry that said invention is permenentaly attached to the car.

It provides the driver and passengers to open and close the windows without interference.

It allows the driver hassle free attachment and removal, no tools necessary.

It permits the driver and passengers to use it because it fits the passengers side as well as the drivers side.

Although the description above contains much specificity, these should not be construed as limiting the scope of the invention but as merely providing illustrations of some of the presently preferred embodiments of the invention. For example, the shade can have other shapes, sizes and color. It can also be made in other kinds of materials, such as metal. The magnets can have several shapes and strengths, etc.

Thus the scope of the invention should be determined by the appended claims and their legal equivalents, rather than by the examples given.

What is claimed is:

1. A shading device for use on an automobile. A visor that is not permenately attached to the vehicle.
said shade is comprised of a thin candy cane shaped sheet of plastic resin. Which is magnetically attached to the top of the door outside of the vehicle. Whereas having major movable positionable shading, impeding transmission of visible sunlight through said shade.
further comprising, heavy duty magnets that are inserted into the boxes which are placed on the fold of said shade and the magnets are held into place with glue whereas to be attached on the vehicle outside the vehicle. Said shade is finished in a UV stablized translucent smoked color which blocks light from passing therethrough.
